(19) United States
(12) Patent Application Publication
(10) Pub. No.: US 2005/0000340 A1
(43) Pub. Date: Jan. 6, 2005

(54) Cutting device for rolled media having dual cutters

(76) Inventor: Kara Petersen, Calgary (CA)

Correspondence Address: SEABY & ASSOCIATES, 603 - 880 WELLINGTON STREET, OTTAWA, K1R 6K7, CA

(21) Appl. No.: 10/609,418

(22) Filed: Jul. 1, 2003

(51) Int. Cl. B26D 1/44; B26D 1/18

(52) U.S. Cl. 83/485; 83/620; 83/425.1; 83/649

(57) ABSTRACT

A cutting device comprises a support to hold a roll of rolled media, a surface upon which the media is unrolled, and first and second cutting guides, each oriented substantially perpendicular to the media's unrolling path and supporting first and second cutters. The first cutter is movably supported by the first cutting guide and is capable of cutting the rolled media substantially parallel to the unrolling path. The second cutter is movably supported by the second cutting guide and is capable of cutting the rolled media substantially perpendicular to the unrolling path. The cutting device further comprises means for releasably securing the first cutter at a desired width position along the first cutting guide.

### FIELD OF THE INVENTION

The present invention relates generally to cutting devices, and more particularly to devices for cutting material dispensed from a roll to a desired length and width.

### BACKGROUND OF THE INVENTION

Media, such as wrapping paper or gift warp, is often stored in “roll” form. Typically, to dispense rolled media, the roll is placed upon a relatively flat surface and manually unrolled to the length desired. Scissors, or other cutting tools, are then used to cut off a piece of media of desired size. However, if the working surface is not truly lever, the roll of media tends to move, due to gravity, in the direction of the down-hill slope of the working surface.

To assist with the dispensing and cutting of such rolled media, and to stop roll movement, various media handling and cutting devices exist in the prior art. For example, U.S. Pat. Nos. 490,561; 788,196; 3,788,175 and 3,821,915 teach a variety cutting devices wherein the rolled media is removably secured a support member, which allows the media to be unrolled, and wherein the media is then guided past a cutter to unroll and cut a desired length of media from the roll. One drawback of these devices is that, although the media is easily cut to a desired length, additional cutting and manipulation of the media must be done to achieve a desired width.

U.S. Pat. No. 5,103,710 to Ross discloses a media handling and cutting device which allows the media to be cut to both a desired length or a desired width; by employing a cutter which is able to turn perpendicularly. However, one drawback of Ross's cutting device is that an operator must use two operations of the device to cut a piece of media to both a desired length and a desired width. Accordingly and referring to the prior cutting device of Ross, as diagrammatically shown in FIGS. 1-3: the operator first holds the cutter at a desired “width position” and pulls the media out across the stationary cutter (FIG. 1); next the operator turns the cutter perpendicularly and moves it across the media to cut the media to the desired length (FIGS. 2-3). Another drawback of Ross's device is that if multiple sheets of media having the same dimensions need to be cut, the operator must pay particular attention at each cutting operation to ensure that the cutter is placed at the proper “width position” prior to each pulling of the media across the cutter.

A device that allows for quick repeated cutting operations of rolled media, to provide sheets of media having both a desired length and width, would be advantageous.

### SUMMARY OF THE INVENTION

It is an object of the present invention to provide a cutting device that allows for the efficient and repeated cutting of rolled media into sheets of desired length and width.

It is a further object of the present invention to provide such a cutting device that is of simple and robust design.

The cutting device of the present invention accomplishes these objects by providing a support to hold a roll of rolled media, a surface upon which the rolled media is unrolled, first and second cutting guides, each oriented substantially perpendicular to the media's unrolling path, and first and second cutters supported in the first and second guides respectively. The first cutter is movably supported by the first cutting guide and is capable of cutting the rolled media substantially parallel to the unrolling path. The second cutter is movably supported by the second cutting guide and is capable of cutting the rolled media substantially perpendicular to the unrolling path. The cutting device further comprises means for releasably securing the first cutter at a desired width position along the first cutting guide.

### BRIEF DESCRIPTION OF THE DRAWINGS

FIGS. 1 to 3 are diagrammatic views illustrating the cutting operation of a prior art cutting device.

FIG. 4 is a perspective view of one embodiment of the invention.

FIGS. 5 to 8 are diagrammatic views illustrating the cutting operation of the present invention.

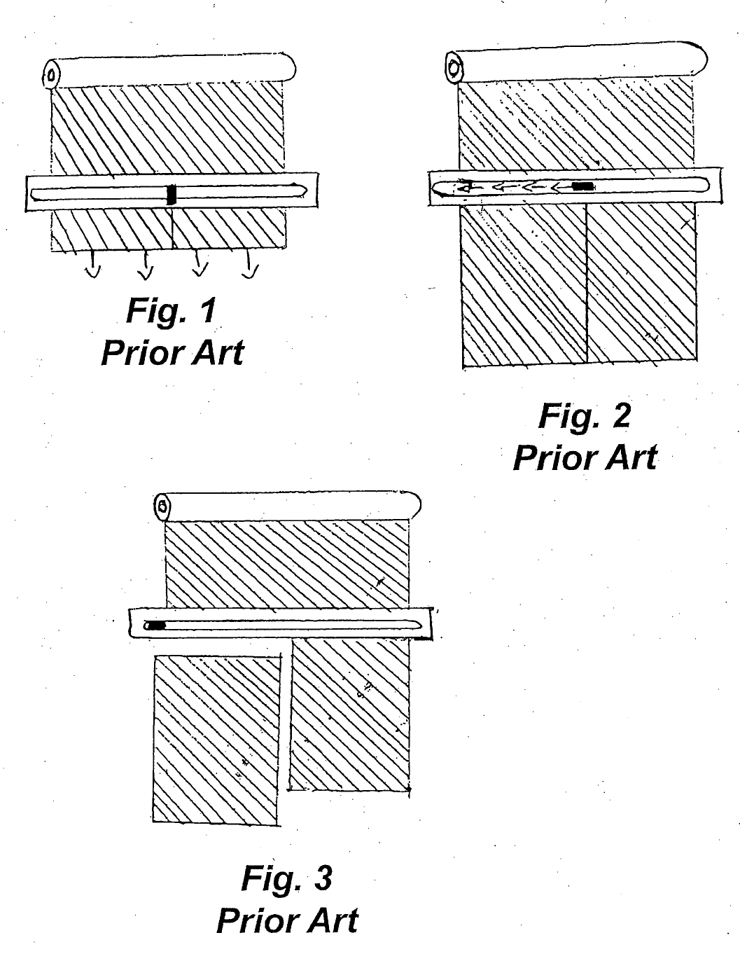

### DETAILED DESCRIPTION OF THE PREFERRED EMBODIMENTS

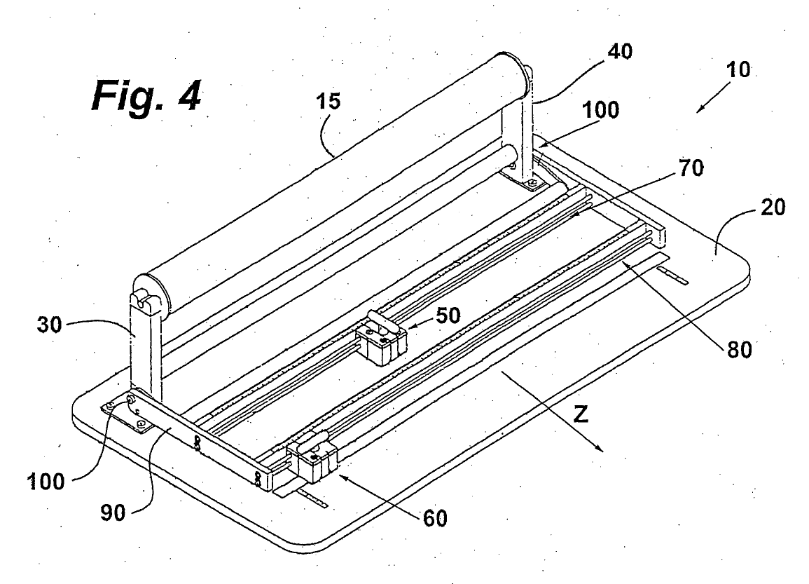

FIG. 4 shows a preferred embodiment of the invention. A dual blade cutting device 10 supports a roll of media 15, such as gift wrap or wrapping paper, and includes a surface 20 upon which the media 15 is unrolled along path Z. The rolled media 15 is supported on the cutting device 10 by means of two media support columns 30 and 40; although other media support means, which allow for easy unrolling of the media 15 along the path Z, are equally suitable. The cutting device 10 further comprises two moveable or slidable cutters 50 and 60 supported on cutter guides 70 and 80. The guides 70, 80 are oriented perpendicular to the path Z of the media 15 as it unrolls across the surface 20. In this embodiment the guides 70, 80 are separate pieces, however, the two guides 70, 80 could also form a single unit without departing from the scope of the invention.

The first cutter 50 is capable of cutting the rolled media 15 substantially parallel to the unrolling path Z, while the second cutter 60 is capable of cutting the rolled media 15 substantially perpendicular to the unrolling path Z. Preferably, the cutters 50, 60 comprise a circular cutting blade (not show) although a variety of different types of cutters are know in the prior art which would be equally suitable. Advantageously, the cutters 50, 60 and guides 70, 80 are supported on a frame 90 pivotally connected to the base of the media support columns 30, 40 at pivot points 100 so as facilitate unrolling of media 15 across the surface 20 prior to cutting.

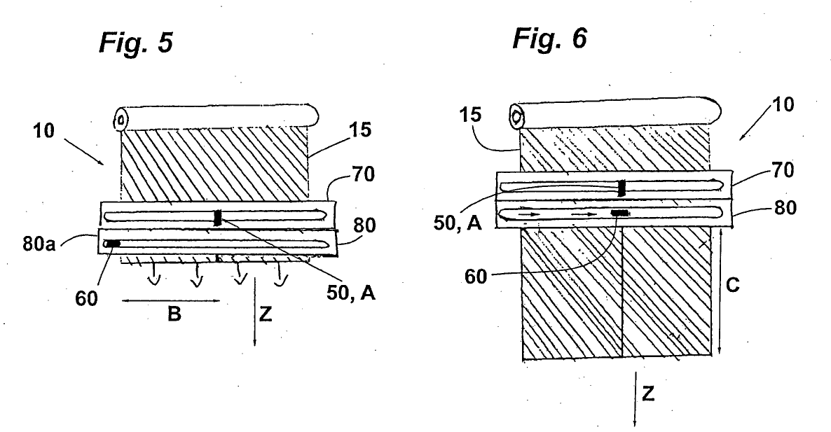

FIG. 5 illustrates the initial steps in the operation of the cutting device 10. For illustrative purposes, only the media 15, the two cutters 50, 60, and the cutter guides 70, 80 are diagrammatically shown. Although the cutters 50, 60 are diagrammatically shown to be within the cutting guides 70, 80 it is understood that a variety of cutter and cutter guide embodiments may be successfully utilized.

To begin the cutting process, the first cutter 50 is releasably secured along the first guide 70 at a desired width location A. The second cutter 60 is placed at a first end 80a of the second guide 80. Various devices and methods for releasably securing cutters along a guide are known in the prior art. In this embodiment frictional forces, or a friction fit, between the first cutter 50 and the first guide 70 are sufficient, during normal cutting operations, to retain the cutter 50 at the desired width location A. Advantageously, the first cutter 50 further comprises a screw tightening device (not shown) to releasably secure the cutter 50 at the desired width location A. Such screw tightening devices are well known in the prior art.

Next, a short portion of the media 15 is unrolled along the path Z and passed by the first cutter 50 and cutter guides 70, 80; thereby cutting the media 15 to a desired width B. In this embodiment the media 15 is passed underneath the cutter guides 70, 80. Other designs of cutters and guides may dictate that the media 15 pass through, or even over top of, such cutters and guides. Preferably, the media cutters 50, 60 and guides 70, 80 are supported on a pivotable frame (not shown) so as to assist with the initial unrolling and passing of the media 15 underneath the cutters 50, 60 and guides 70, 80.

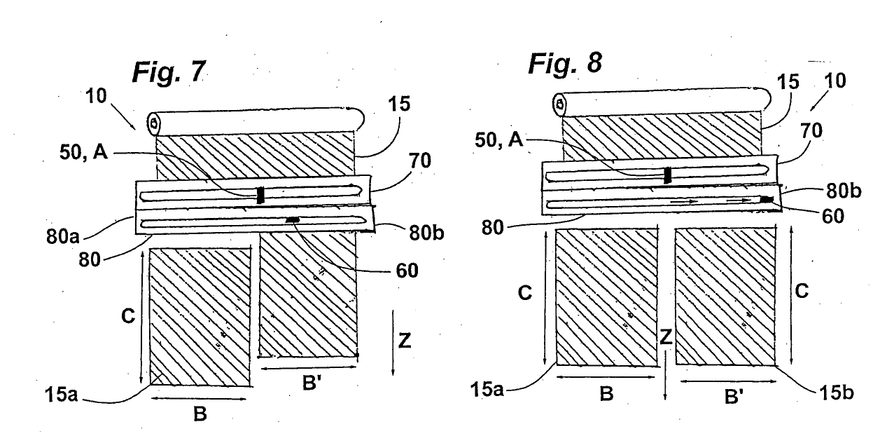

Referring now to FIGS. 6 to 8, the media 15 is pulled along the path Z until a desired length C is reached. When the desired length C is reached, the second cutter 60 is moved from its location at the first end 80a of the second guide 60 to the desired width position A, thereby making a length-wise cut and completely cutting off a piece of media 15a, from the rolled media 15, having both a desired length C and a desired width B. By continuing to move the second cutter 60 away from the first end 80a completely towards a second end 80b, a second piece of media 15b, having a desired length C and a width B′, is cut off of the rolled media 15. If the desired width position A is exactly halfway across the total width of the rolled media 15, then both cut pieces 15a and 15b will have the same “desired” width B (i.e. B′ is the same size as B).

Advantageously, the first cutter 50 remains secured at position A while the second cutter 60 can be easily and repeatedly moved between the first 80a and second 80b ends as media 15 is pulled through the device 10 to the desired length C; so as to quickly and efficiently produce multiple cut media pieces 15a, 15b each having desirable lengths C and desirable widths B, B′. As the first cutter 50 remains secured at the desired width position A, an operator no longer needs to pay particular attention to returning a cutter to the desired width position A between each length-wise cut as was the case in the prior art.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1-5. (cancelled)

6. The media cutting device of claim 8, wherein the media support means comprises media support columns.

7. The media cutting device of claim 8, wherein the pivotable frame is connected to the media support columns.

8. A rolled media cutting device comprising:
media support means for supporting at least one roll of rolled media;
a surface upon which the rolled media can be unrolled for movement along a path of travel;
first and second parallel cutting guides extending perpendicular to the path of travel of unrolled media over said surface;
a frame pivotable with respect to said surface carrying said first and second cutting guides;
a first cutter slidable on the first cutting guide for cutting the unrolled media in the direction of the path of travel of the media;
a second cutter slidable on the second cutting guide for cutting the unrolled media perpendicular to the path of travel of the media; and
securing means for releasably securing said first cutter at a desired width position on said first cutting guide.
